(19) United States
(12) Patent Application Publication
(10) Pub. No.: US 2021/0222806 A1
(43) Pub. Date: Jul. 22, 2021

(54) END BLOCK DEVICE FOR FLANGE-TYPE FITTINGS

(71) Applicant: Peter Lacavalla, Westchester, NY (US)

(72) Inventor: Peter Lacavalla, Westchester, NY (US)

(21) Appl. No.: 17/062,510

(22) Filed: Oct. 2, 2020

Related U.S. Application Data
(60) Provisional application No. 62/962,685, filed on Jan. 17, 2020.

(51) Int. Cl. F16L 23/028

(52) U.S. Cl. CPC F16L 23/0286

(57) ABSTRACT

An end block for a flange-type hydraulic hose fitting includes a main body having a top surface, and a planar bottom surface. A plurality of openings are positioned on the main body at locations that correspond to the bolt holes of a specific size hydraulic hose fitting. The plurality of openings including an elongated shape to accommodate differences in bolt hole spacings for different pressure code ratings of the same size hose. The main body is constructed from a high pressure material for allowing the hydraulic hose to be pressurized with the main body bolted thereto. A protrusion extends outward from the top surface, and a gasket surrounds the protrusion. The protrusion includes an outside diameter that is complementary to the outside diameter of the hydraulic hose, and is positionable within the port hole of a hydraulic component which is sized to receive the hydraulic hose.

### CROSS-REFERENCE TO RELATED APPLICATIONS

This application claims the benefit of U.S. Application Ser. No. 62/962,685 filed on Jan. 17, 2020, the contents of which are incorporated herein by reference.

### TECHNICAL FIELD

The present invention relates generally to the field of hydraulic equipment, and more particularly to an end block device for a flange-type fitting.

### BACKGROUND

The statements in this section merely provide background information related to the present disclosure and may not constitute prior art.

Commercial grade hydraulic-operated equipment such as excavators, cranes and the like operate at pressure ranges that are categorized into a specific pressure code such as SAE code 61 (500-3000 PSI) or code 62 (up to 6,000 PSI), and/or Caterpillar® ratings, among others, for example. Owing to these high pressures, traditional twist-type hose connectors would immediately fail. As such, these systems utilize a flange fitting along the distal ends of the hydraulic hose which receives a clamp having a plurality of bolts that secures the hose to various components such as a pump, valve block or hydraulic cylinder, for example.

Throughout the life of the equipment, it becomes necessary to sometimes disconnect certain components such as a hydraulic cylinder from a vehicle. When this happens, the hydraulic fluid within the hose that has been disconnected flows out through the open end and leaks into the surrounding work area. Additionally, the hydraulic fluid within the cylinder (or other such component) itself will leak out of the exposed port hole/opening. Further, when the port hole is left uncovered, any number of harmful contaminants such as water, dirt or sand, for example, can enter into the component body through the exposed opening.

In order to cure this situation, it is known in the art to attempt to plug the openings by using a plastic cap, rag or other such article that can be held over the open hydraulic hose. More recently, there are known screw-type caps which are designed and sized to be screwed onto the end of a hydraulic hose. Although such devices are useful in reducing spillage of hydraulic fluid, they can only be used when the system is completely unpressurized.

As a result, current safety protocols require the entire machine/vehicle must remain inoperable until each disconnected hydraulic hose has been reconnected. This is to prevent an accidental pressurization of a disconnected hydraulic hose whereby the high pressure of the fluid will turn the plug into a projectile with possible deadly consequences.

Accordingly, it would be beneficial to provide an end block device for flange-type fittings that can function to securely mate with the flange fitting of a hydraulic hose in order to prevent leakage of hydraulic fluid, that can be used regardless of whether the hose is in a non-pressurized state or a pressurized state. It would also be beneficial if the same component could be used to securely plug the opening of a cylinder or other such piece of equipment, so as to prevent stored fluid from leaking therefrom and to prevent contaminants from entering through the exposed opening.

### SUMMARY OF THE INVENTION

The present invention is directed to an end block for a flange-type hydraulic hose fitting. One embodiment of the present invention can include a generally rectangular-shaped main body having a top surface, a planar bottom surface and a plurality of side edges. A plurality of openings can be positioned along the main body at locations that correspond to the location of bolt holes on the hydraulic hose fitting.

In one embodiment, the plurality of openings can include an elongated shape so as to be able to be aligned with the bolt holes for multiple pressure ratings provided on the same size hydraulic hose, and to allow the main body to be bolted to the end of the hydraulic hose. The main body can be constructed from a high pressure material and the hydraulic hose can be pressurized when the main body is bolted thereto.

In one embodiment, a generally cylindrical shaped protrusion can be positioned along the center of the top surface, and a gasket can be positioned adjacent to the protrusion. The protrusion can include an outside diameter that is complementary to the outside diameter of the hydraulic hose, and can be configured to be inserted within the port hole of a hydraulic component which is sized to receive the hydraulic hose.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of an end block device that is useful for understanding the inventive concepts disclosed herein.

FIG. 2 is a bottom view of the end block device, in accordance with one embodiment of the invention.

FIG. 3A is a perspective view of the end block device in operation with a hydraulic hose, in accordance with one embodiment of the invention.

FIG. 3B is another perspective view of the end block device in operation with a hydraulic hose, in accordance with one embodiment of the invention.

FIG. 4A is a perspective view of the end block device in operation with a hydraulic component, in accordance with one embodiment of the invention.

FIG. 4B is another perspective view of the end block device in operation with a hydraulic component, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As described herein, the term “removably secured,” and derivatives thereof shall be used to describe a situation wherein two or more objects are joined together in a non-permanent manner so as to allow the same objects to be repeatedly joined and separated.

As described throughout this document, the term “complementary shape,” and “complementary dimension,” shall be used to describe a shape and size of a component that is identical to, or substantially identical to the shape and size of another identified component within a tolerance such as, for example, manufacturing tolerances, measurement tolerances or the like.

As described herein, the terms “connector” and “complementary connector” include any number of different elements that work together to repeatedly join two items together in either a permanent or nonpermanent manner. Several nonlimiting examples include opposing strips of hook and loop material (i.e. Velcro®), attractively-oriented magnetic elements, tethers such as wire, ropes or zip ties, buckles, and/or compression fittings such as T-handle rubber draw latches, locking pins, male and female fittings, clamps, and nut/bolts, for example.

As described throughout this document, the term “about” “approximately” and “substantially” shall be used interchangeably to describe a feature, shape or measurement of a component within a tolerance such as, for example, manufacturing tolerances, measurement tolerances or the like.

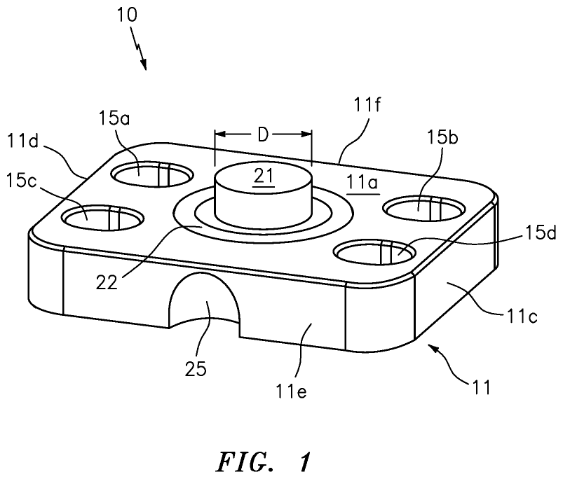

FIGS. 1-4B illustrate one embodiment of an end block device 10 for a flange-type fitting that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

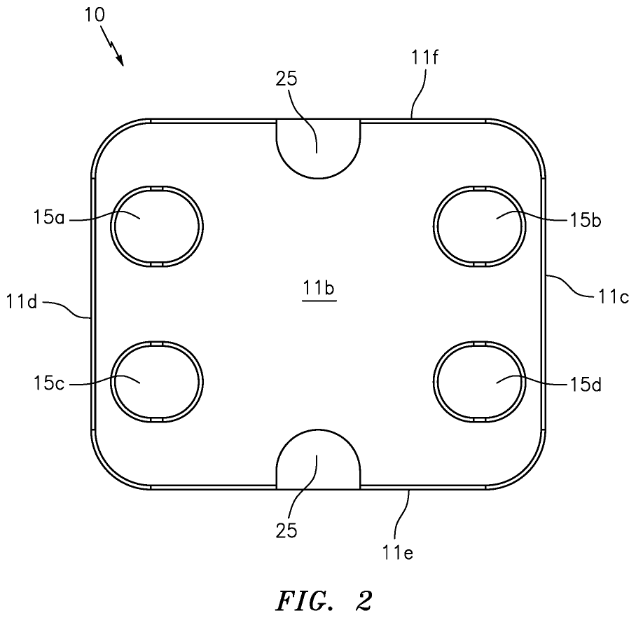

As shown best in FIGS. 1 and 2, one embodiment of the device 10 can include a generally rectangular-shaped main body 11 having a top surface 11a, a bottom surface 11b, a front edge 11c, a back edge 11d and a pair of side edges 11e and 11f. In the preferred embodiment, the main body will be constructed from a high-strength and pressure resistant material such as steel or aluminum, for example, that is manufactured to be in continuous communication with fluids at pressures between 500 PSI to 6,000 PSI, so as to be used with code 61 and code 62 hydraulic systems without failing.

When secured in the manner herein described, such a feature advantageously allows the hydraulic system and hose to which the device 10 is secured to be fully pressurized, thus reducing or eliminating the inherent dangers and drawbacks described above. Moreover, the use of aluminum advantageously allows the block to remain lightweight and to be used in marine environments without degrading due to rust over time. Of course, other embodiments are contemplated wherein the main body is constructed from one or more other types of hardened metals and/or materials suitable for withstanding the pressures and operating environments described herein.

In one embodiment, four bolt openings 15a, 15b, 15c and 15d can be positioned along the main body, and can extend through the front surface 11a and the back surface 11b. Each of the bolt openings can be positioned so as to align with the bolt openings on a hydraulic hose flange fitting, so as to secure the main body 11 to the end of the hose via the same grade 8 bolts that are used to secure the hose to a piece of equipment.

In one embodiment, each of the openings 15a-15d can include a shape and a dimension that is complementary to the shape and dimension of the bolt openings on a hydraulic hose flange fitting having a specific pressure code. For example, when constructed for use with a #12, ¾ inch hydraulic hose with a code 61 pressure rating, the center of openings 15a and 15c can be positioned 1.9 inches from openings 15b and 15d, respectively, and the center of openings 15a and 15b can be positioned 0.875 inches from openings 15c and 15d, respectively. Such dimensions mirroring the dimensions of the bolt openings found on the noted hose.

Likewise, when constructed for use with a #12, ¾ inch hydraulic hose with a code 62 pressure rating, the center of openings 15a and 15c can be positioned 2 inches from openings 15b and 15d, respectively, and the center of openings 15a and 15b can be positioned 0.937 inches from openings 15c and 15d, respectively. Such dimensions mirroring the dimensions of the bolt openings found on the noted hose.

However, in the preferred embodiment, each of the openings 15a, 15b, 15c and 15d can include an elongated, generally elliptical shape. By providing elongated openings, it is possible for a single device 10—that is sized for use with a particular size hydraulic hose and flange fitting- to accommodate the variances in bolt patterns found between multiple pressure codes. As such, in the above examples, the elongated openings 15a-15d are positioned so as to align with the bolt openings of a #12, ¾ inch hydraulic hose having either a code 61 or code 62 pressure rating, for example.

Although described above with regard to a particular size, shape and pressure rating, this is for exemplary purposes only. To this end, the device 10 can be manufactured to be operable with hoses and flange fittings of any manufacturer and size, such as #12, #16, #20, #24 or #32, for example, along with any number of different pressure code ratings. Additionally, other embodiments are contemplated where there main body can include a different shape, and/or a different number of openings that can be arranged in any orientation, so as to be compatible for use with any number of different flange fitting systems.

In one embodiment, a protrusion 21 can be positioned along the top surface 11a of the main body and can extend outward therefrom. In the preferred embodiment, the protrusion 21 will include a cylindrical shape having a specified diameter D, and that is positioned at the center of the top surface 11a. As noted above, the main body 11 will be manufactured so as to be utilized with specifically sized hydraulic hoses. As such, the protrusion 21 will preferably include a diameter D that is complementary to the outside diameter of the specified hose size, and/or that is complementary to the port hole on the component to which the specified hose is to be connect.

Thus, the protrusion 21 of the device 10 in the above examples, would include an outside diameter D of approximately ¾ inches, and a height of at least ¼ inches, so as to be positionable within a port hole of a cylinder or other such component that is manufactured to receive to receive a #12, ¾ inch hydraulic hose having either a code 61 or code 62 pressure rating.

Of course, other embodiments are contemplated wherein the protrusion can include any number of different shapes and sizes, and can be formed as an integral part of the main body at a time of construction or can be constructed from a different material and can be positioned along the bottom surface in accordance with known manufacturing techniques.

In one embodiment, a resilient gasket 22 can be positioned along the top surface of the main body 11a, and can surround the protrusion 21. In one embodiment, the gasket can comprise an elastomeric rubber O-ring, for example, that can function to create a seal between the top surface 11a of the main body, and the top surface of the cylinder or other component to which the device 10 is to be secured.

In one embodiment, a pair of slotted guides 25 can be positioned along two or more sides of the device body, and can function to receive a connector 40 such as a zip tie, for example, that can secure the device onto the hydraulic component. Although described as including slotted guides along the sides of the main body, this is for illustrative purposes only. To this end, the device 10 can include, or can be configured to be used with any number of different types of connectors capable of removably securing the main body onto a piece of equipment so as to cover the hose opening.

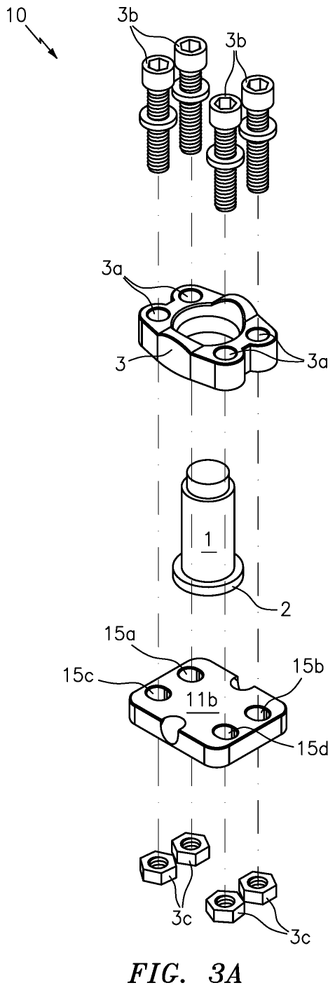

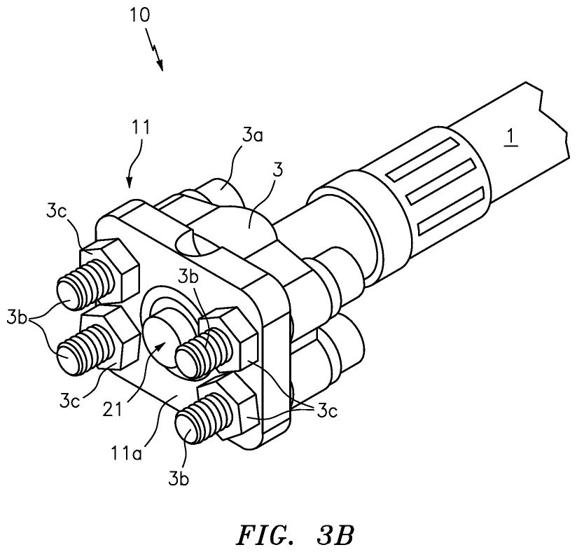

FIGS. 3A and 3B illustrate one embodiment of the device 10 in operation to cap a hydraulic hose 1 having a flanged end 2 and a flange fitting 3. As shown, the flanged end of the hose 1 and the fitting 3 can be positioned onto the bottom surface 11b of the main body. When so positioned, the bolt holes 3a of the fitting will be aligned with openings 15a-15d, and four grade-8 bolts 3b can be passed through both sets of openings.

Next, each of the bolts can receive a grade-8 nut 3c which can be tightened to the same torque rate for the size flange that is being sealed off. As noted above, the elongated shape of openings 15a-15d allows a single device 10 to function with hoses having different code pressure ratings. Accordingly, when secured as described, the hose 1 can be pressurized while the device 10 is secured thereto, thus eliminating the need to keep the entire system inoperable.

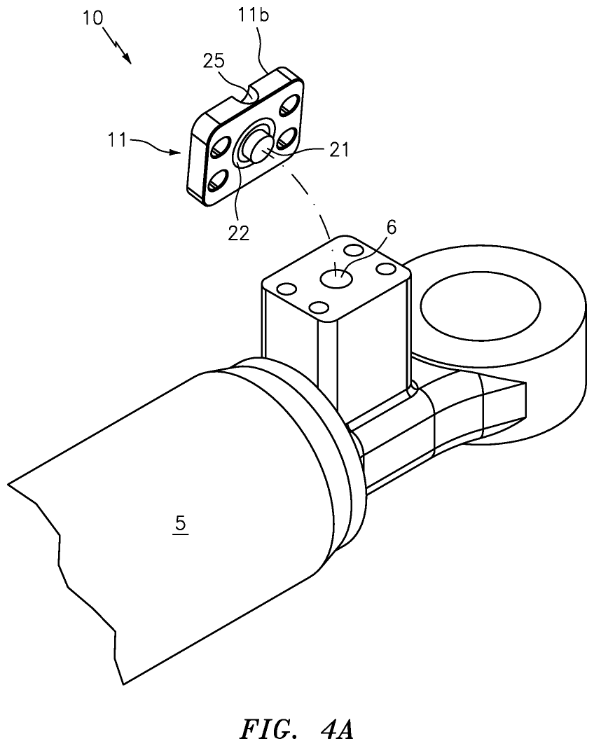

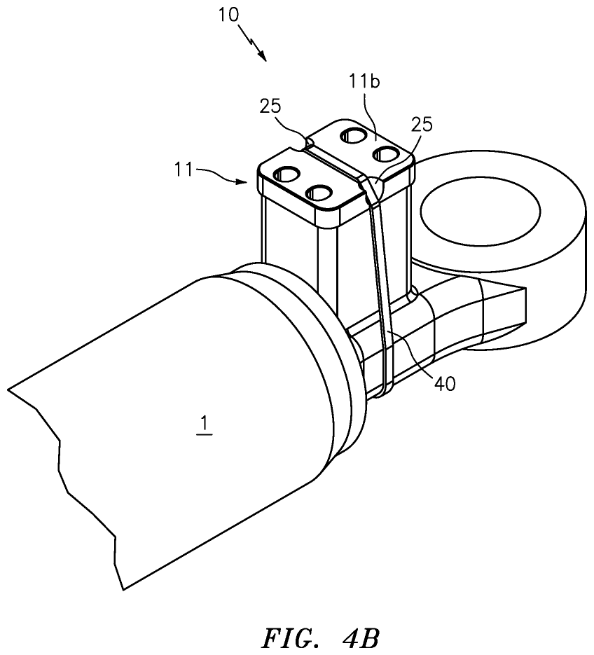

FIGS. 4A and 4B illustrate one embodiment of the device 10 in operation to cap a component such as the illustrated hydraulic cylinder 5, for example. As shown, the protrusion 21 can be aligned and then positioned within the port hole 6 of the component, at which time the O-ring 22 will be in contact with the surface of the cylinder. Next, a connector 40 such as the illustrated zip tie, for example, can be secured around the component and can be held in place via the slotted guides 25.

Although not specifically illustrated, it is noted that the openings 15a-15d of the main body will align with the bolt openings on the cylinder. Therefore, a user may utilize the above described bolts 3b to secured the device 10 onto the component in addition to, or instead of using the connector 40.

In either instance, when the protrusion 21 is positioned within the opening 6, and the main body 11 is secured to the component via the connector 40 and/or bolts 3b, the device 10 advantageously functions to securely plug the port hole of a piece of hydraulic equipment so as to prevent leakage of fluids and/or entry of contaminants.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the terms “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. An end block device for a hydraulic hose having a known size, a known pressure code, and a flange fitting, said end block device comprising:
a main body having a top surface, a planar bottom surface and a plurality of side edges;
a plurality of openings that are positioned along the main body, said plurality of openings extending through the front surface and the back surface of the main body;
wherein the planar bottom surface includes a cross sectional dimension that is greater than a cross sectional dimension of the hydraulic hose,
wherein each of the plurality of openings are positioned at a location that is complementary to a location of a plurality of bolt holes on the flange fitting when the flange fitting is positioned against the bottom surface, and
wherein each of the plurality of openings are configured to receive a bolt that is positioned through one of the plurality of bolt holes.

2. The device of claim 1, wherein the main body is constructed from a material having a pressure rating of at least 500 PSI.

3. The device of claim 2, wherein the material comprises a single aluminum block

4. The device of claim 1, wherein the main body is constructed from a material having a pressure rating of up to 6000 PSI.

5. The device of claim 4, wherein the material comprises a single aluminum block.

6. The device of claim 1, further comprising:
a protrusion that is positioned along the top end of the main body.

7. The device of claim 6, wherein the protrusion extends perpendicular to a major axis of the main body, and is formed as an integral component as the main body.

8. The device of claim 7, wherein the protrusion includes a cylindrical shape and has an outside diameter that is complementary to an outside diameter of the hydraulic hose.

9. The device of claim 8, further comprising:
a gasket that is positioned along the top surface of the main body at a location surrounding the protrusion.

10. The device of claim 9, wherein the protrusion includes a height of at least ¼ inches, and is configured to be inserted within a port hole of a hydraulic component that is sized to receive the hydraulic hose.

11. The device of claim 1, wherein the known size of the hydraulic hose comprises at least one of a number 12, number 16, number 20, number 24 or number 32 hydraulic hose.

12. The device of claim 1, further comprising:
a plurality of nuts, each of said nuts being configured to engage the bolt that is positioned through one of the plurality of openings.
